(19) United States
(12) Patent Application Publication
(10) Pub. No.: US 2010/0141614 A1
(43) Pub. Date: Jun. 10, 2010

(54) Plasma display apparatus

(76) Inventors: Kwon Sohn, Suwon-si (KR); Ik-Sang Lee, Suwon-si (KR); Hyun-Ye Lee, Suwon-si (KR)

Correspondence Address: CHRISTIE, PARKER & HALE, LLP, PO BOX 7068, PASADENA, CA, 91109-7068, US

(21) Appl. No.: 12/592,478

(22) Filed: Nov. 25, 2009

(30) Foreign Application Priority Data
Dec. 4, 2008 (KR) 10-2008-0122598

(51) Int. Cl. H01J 61/52; G09G 5/00

(52) U.S. Cl. 345/204; 313/46

(57) ABSTRACT

A plasma display apparatus includes a plasma display panel, a chassis base at the rear of the plasma display panel and having a plurality of channels for guiding heated air to flow upwardly, and a thermal conductive medium between the plasma display panel and the chassis base.

### CROSS-REFERENCE TO RELATED APPLICATION

This application claims priority to and the benefit of Korean Patent Application No. 10-2008-0122598, filed on Dec. 4, 2008, in the Korean Intellectual Property Office, the disclosure of which is incorporated herein in its entirety by reference.

### BACKGROUND OF THE INVENTION

1. Field of the Invention

The embodiments of present invention relates to a plasma display apparatus, and more particularly, to a plasma display apparatus having an improved chassis base.

2. Description of the Related Art

Plasma display apparatuses display images using a gas discharge phenomenon. The plasma display apparatus includes a plasma display panel (PDP) for displaying an image using plasma discharge, a chassis base for supporting the PDP, and a plurality of circuit boards installed on the chassis base.

The PDP displays an image using a discharge mechanism in which light is emitted by plasma discharge that is generated by applying high voltage to a discharge cell that is filled with gas. Accordingly, a large amount of heat is generated in the PDP.

If the heat generated in the PDP is not appropriately dissipated, many problems may occur. For example, since heat is concentrated at a certain area, the quality of an image is deteriorated. Also, since the PDP is heated above an appropriate temperature, the life span of a fluorescent substance included in the PDP may be shortened.

Conventionally, the heat generated during the operation of the PDP is externally dissipated using natural convection of air in the plasma display apparatus. Natural convection heat dissipation is a technology using a chassis base attached to the PDP. The heat generated in the PDP is dissipated out of the plasma display apparatus via the chassis base.

Recently, as a demand for large screen displays has increased, the size of plasma display apparatuses has increased. Accordingly, since a large amount of heat may be generated by a large PDP, heat dissipation performance of the chassis base needs to be further improved.

### SUMMARY OF THE INVENTION

Embodiments of the present invention provide a plasma display apparatus having improved heat dissipation performance.

Embodiments of the present invention provide a plasma display apparatus having a chassis base capable of efficiently dissipating heat without increasing the thickness of the chassis base.

According to an embodiment of the present invention, there is provided a plasma display apparatus which includes a plasma display panel, a chassis base at the rear of the plasma display panel and having a plurality of channels for guiding heated air to flow upwardly, and a thermal conductive medium arranged between the plasma display panel and the chassis base.

The channels may extend upwardly in the chassis base, be formed on a side of the chassis base facing the thermal conductive medium, and be formed on a side of the chassis base facing away from the thermal conductive medium. Each of the channels may form a duct having a convex cross section protruding away from the chassis base in a direction away from the thermal conductive medium.

According to another embodiment of the present invention, there is provided a plasma display apparatus which includes a plasma display panel, a thermal conductive medium at the rear of the plasma display panel, and a chassis base having a plurality of installation portions, the installation portions attached to the plasma display panel via the thermal conductive medium between the installation portions and the plasma display panel, and a plurality of connection portions connecting the installation portions and protruding in an opposite direction from the plasma display panel to be separated from the thermal conductive medium.

The installation portions and the connection portions may vertically extend in the chassis base. The cross section of each of the connection portions may have a polygonal shape. The cross section of each of the connection portions may have a shape of a circular arc.

According to another embodiment of the present invention, there is provided a plasma display apparatus including a plasma display panel, a chassis base thermally coupled to the plasma display panel, and driving circuits on a side of the chassis base opposite from the plasma display panel. The chassis base is adapted to provide a plurality of air channels substantially separated from air flow across the driving circuits for guiding air heated by the plasma display panel.

### BRIEF DESCRIPTION OF THE DRAWINGS

The patent or application file contains at least one drawing executed in color. Copies of this patent or patent application publication with color drawing(s) will be provided by the Office upon request and payment of the necessary fee.

The above and other features and aspects of the present invention will become more apparent by describing in detail exemplary embodiments thereof with reference to the attached drawings in which:

FIG. 1 is a schematic drawing illustrating an exploded perspective view of a plasma display apparatus according to an exemplary embodiment of the present invention;

FIG. 2 is a schematic drawing illustrating a side cross-sectional view of the plasma display apparatus of FIG. 1;

FIG. 3 is a schematic drawing illustrating a top cross-sectional view of the plasma display apparatus of FIG. 1;

FIG. 4 is an image showing a temperature distribution in a comparative test example of a conventional plasma display apparatus;

FIG. 5 is an image showing a temperature distribution in a range of 25° C.-55° C. in the comparative example of FIG. 4;

FIG. 6 is an image showing a temperature distribution in a test example of a plasma display apparatus according to an exemplary embodiment of the present invention;

FIG. 7 is an image showing a temperature distribution in a range between 25° C.-55° C. in the test example of FIG. 6;

FIG. 8 is an image showing a temperature distribution, which illustrates air flow and a thermal boundary layer analyzed in a cross section of a center portion of the plasma display apparatus in the comparative test example of FIG. 4;

FIG. 9 is an image showing a temperature distribution by magnifying a portion A of FIG. 8;

FIG. 10 is an image showing a temperature distribution, which illustrates air flow and a thermal boundary layer analyzed in a cross section where a scan buffer board of the plasma display apparatus in the comparative test example of FIG. 4 exists;

FIG. 11 is an image showing a temperature distribution by magnifying a portion B of FIG. 10;

FIG. 12 is an image showing a temperature distribution, which illustrates air flow and a thermal boundary layer analyzed in a cross section of an installation portion of the plasma display apparatus in a test example in relation with the exemplary embodiment of FIG. 1;

FIG. 13 is an image showing a temperature distribution by magnifying a portion C of FIG. 12;

FIG. 14 is an image showing a temperature distribution, which illustrates air flow and a thermal boundary layer analyzed in a cross section of a connection portion of the plasma display apparatus in a test example in relation with the exemplary embodiment of FIG. 1;

FIG. 15 is an image showing a temperature distribution by magnifying a portion D of FIG. 14;

FIG. 16 is an image showing a fluid velocity distribution of the plasma display apparatus in a test example in relation with the exemplary embodiment of FIG. 1;

FIG. 17 is a schematic drawing illustrating a top cross-sectional view of a plasma display apparatus according to another exemplary embodiment of the present invention;

FIG. 18 is a schematic drawing illustrating a top cross-sectional view of a plasma display apparatus according to another exemplary embodiment of the present invention; and

FIG. 19 is a schematic drawing illustrating a top cross-sectional view of a plasma display apparatus according to another exemplary embodiment of the present invention.

### DETAILED DESCRIPTION OF EXEMPLARY EMBODIMENTS

The attached drawings for illustrating exemplary embodiments of the present invention are referred to in order to gain a sufficient understanding of the present invention, the merits thereof, and aspects of the embodiments of the present invention. Hereinafter, the present invention will be described in detail by explaining exemplary embodiments of the invention with reference to the attached drawings. Like reference numerals in the drawings denote like elements.

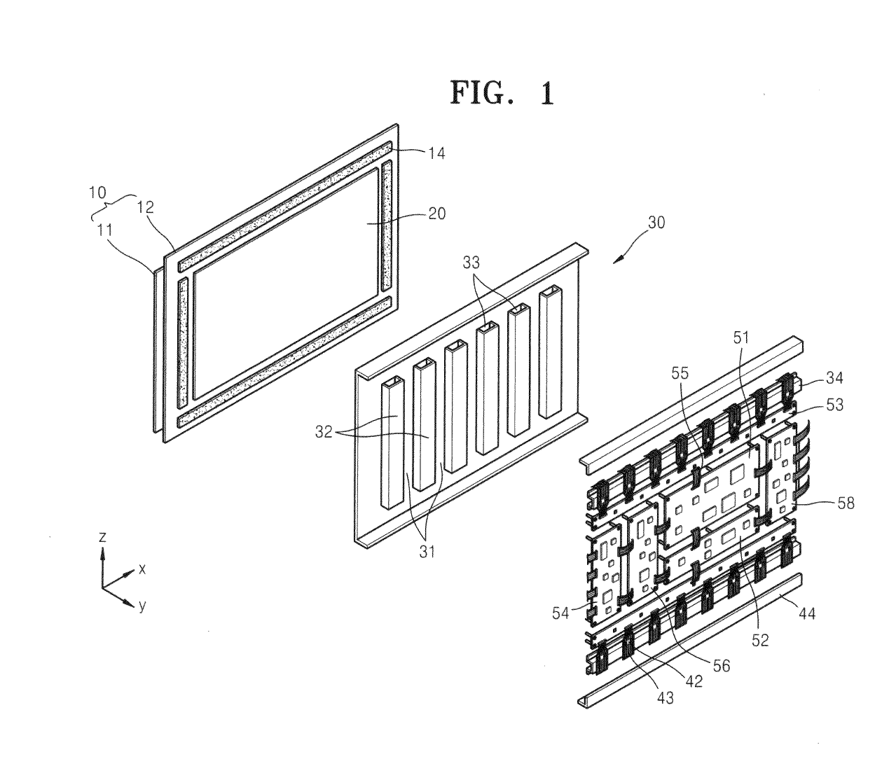

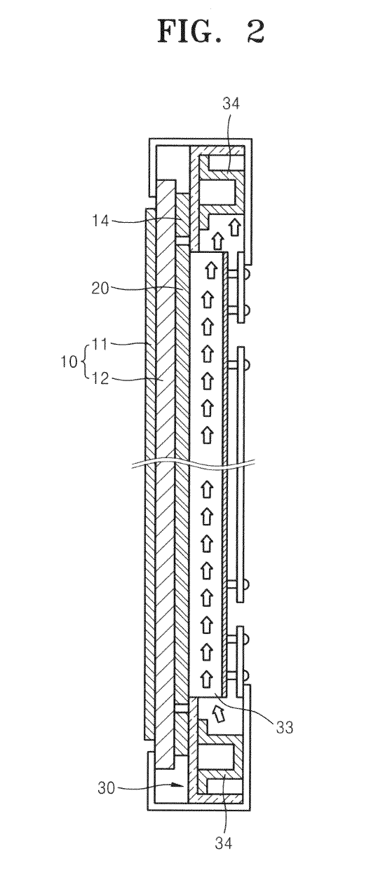

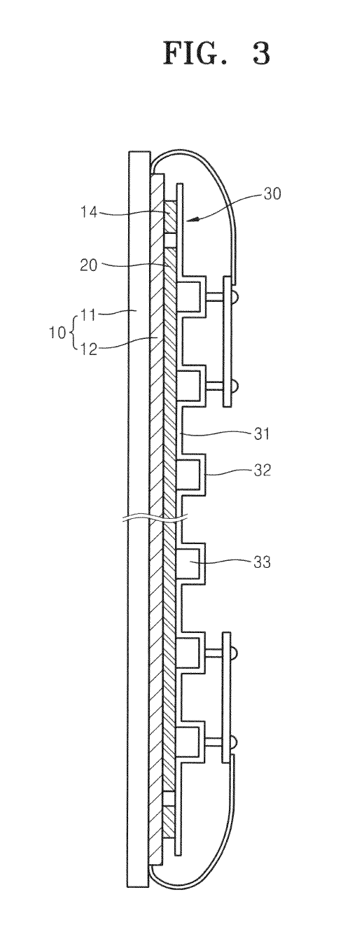

FIG. 1 is a schematic drawing illustrating an exploded perspective view of a plasma display apparatus according to an exemplary embodiment of the present invention. FIG. 2 is a schematic drawing illustrating aside cross-sectional view of the plasma display apparatus of FIG. 1. FIG. 3 is a schematic drawing illustrating a top cross-sectional view of the plasma display apparatus of FIG. 1.

Referring to FIGS. 1-3, a plasma display apparatus according to the present exemplary embodiment includes a plasma display panel (PDP) 10 for forming an image using a gas discharge phenomenon, a thermal conductive medium 20 arranged on the rear surface of the PDP 10, and a chassis base 30.

The PDP 10 includes a front substrate 11 and a rear substrate 12 which are arranged to face each other. A plurality of discharge spaces defined by a plurality of partition walls are formed between the front and rear substrates 11 and 12. An address electrode and a display electrode that includes a pair of a sustain electrode and a scan electrode are arranged to cross each other in each of the discharge spaces. When a drive signal is applied to the address electrode and the display electrode, gas discharge is generated in the discharge space. Visible light rays are emitted from the discharge space toward the front substrate 11 due to the gas discharge so that an image may be displayed.

The chassis base 30 is installed in the rear of the rear substrate 12 of the PDP 10. The chassis base 30 supports the PDP 10 and a plurality of circuit boards 51, 52, 53, 54, 56, and 58. Accordingly, the chassis base 30 is formed of a material exhibiting a superior mechanical strength such as aluminium.

The thermal conductive medium 20 and a double-sided adhesive tape 14 are interposed between the rear surface of the PDP 10 and the front surface of the chassis base 30. The thermal conductive medium 20 conductively transfers and disperses heat generated in the PDP 10 due to the gas discharge in a direction along an x-z plane. The thermal conductive medium 20 may be an acryl-based heat dissipation sheet, a graphite-based heat dissipation sheet, a metal-based heat dissipation sheet, or a carbon nanotube-based heat dissipation sheet which exhibits superior thermal conductivity.

As the PDP 10 and the chassis base 30 are attached to each other using the double-sided adhesive tape 14, the thermal conductive medium 20 may be closely arranged on the rear surface of the PDP 10 and the front surface of the chassis base 30.

The chassis base 30 is provided with a plurality of channels or grooves 33 for guiding heated air to flow upwardly (e.g., z direction in FIG. 1). The chassis base 30 includes a plurality of installation portions 31 and a plurality of connection portions 32 connecting the installation portions 31. The installation portions 31 are attached to the PDP 10 via the thermal conductive medium 20 interposed between the installation portions 31 and the PDP 10. Since the connection portions 32 protrude in a direction away from the PDP 10 to be separated from the thermal conductive medium 20, the channels 33 may be formed in the chassis base 30 by the connection portions 32. The installation portions 31 and the connection portions 32 of the chassis base 30 may be manufactured by a press process or die-cast molding.

The circuit boards 51, 52, 53, 54, 56, and 58 and a power unit (not shown) are installed at the rear of the chassis base 30. A driver chip for driving the PDP 10 and other electronic devices are installed on the circuit boards 51, 52, 53, 54, 56, and 58. The circuit boards 51, 52, 53, 54, 56, and 58 are installed on the rear surface of the chassis base 30 and coupled to the chassis base 30 via an installation member such as boss. The circuit boards 51, 52, 53, 54, 56, and 58 include a switching-mode power supply (SMPS) 51, a logic board 52, a scan buffer board 54, a scan drive board 56, a sustain drive board 58, and an address buffer board 53.

The SMPS 51 supplies power to a drive circuit (not shown) and the PDP 10 and includes an AC/DC converter for converting an incoming AC voltage to a DC voltage. The SMPS 51 is electrically connected to the address buffer board 53 and the logic board 52 via a flexible flat cable (FFC) 55 to supply power.

A reinforcement member 34 for preventing bending or deformation of the chassis base 30 is formed on the rear surface of the chassis base 30. As the size of the PDP 10 increases, the size of the chassis base 30 increases accordingly so that the chassis base 30 may be bent due to its own weight or an externally applied load. The reinforcement member 34 supports the chassis base 30 to prevent the chassis base 30 from being bent or deformed due to the external load or heat.

The scan buffer board 54 buffers an input signal for the scan electrode. The scan drive board 56 generates a scan signal in synchronization with a signal of a timing controller (not shown) and supplies the scan signal to the scan electrode. The sustain drive board 58 generates an input signal for the sustain electrode. The address buffer board 53 includes an intelligence power module (IPM), a timing controller, a signal input terminal, and a circuit portion for data processing, to control the address electrode.

The address buffer board 53 is electrically connected to the PDP 10 via a tape carrier package (TCP) 43 on which a driver IC 42 for generating a control signal applied to the address electrode is mounted. The TCP 43 is protected by a protection plate 44 coupled to the chassis base 30.

According to the above-described embodiment, since the heated air of the PDP 10 flows upwardly through the channels 33 of the chassis base 30, the heat dissipation performance of a plasma display apparatus may be improved without increasing the thickness of the chassis base 30.

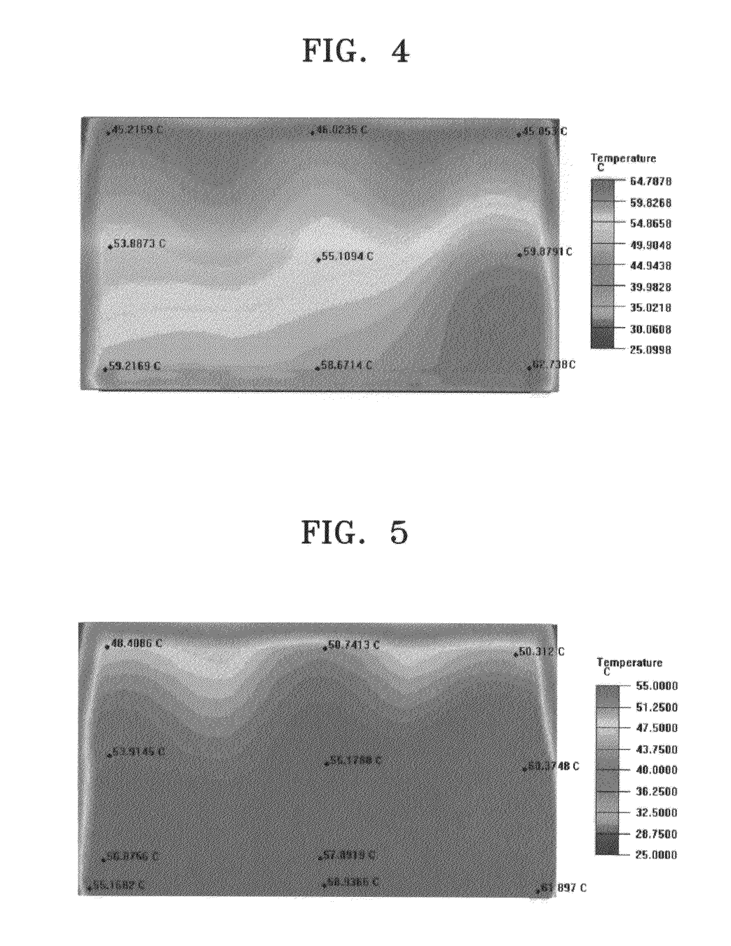

FIG. 4 is an image showing a temperature distribution in a comparative test example of a conventional plasma display apparatus. FIG. 5 is an image showing a temperature distribution in a range of 25° C.-55° C. in the comparative example of FIG. 4.

The comparative test example of FIGS. 4 and 5 shows temperature distributions generated when a PDP is driven in a conventional plasma display apparatus having a flat chassis base. In detail, the highest temperature is generated in the lower right side of the PDP and the difference in temperature in the left and right sides of the PDP is large. This is because the heat generated in the TCP 43 and the sustain drive board 58 is not externally dissipated but concentrates at a particular area.

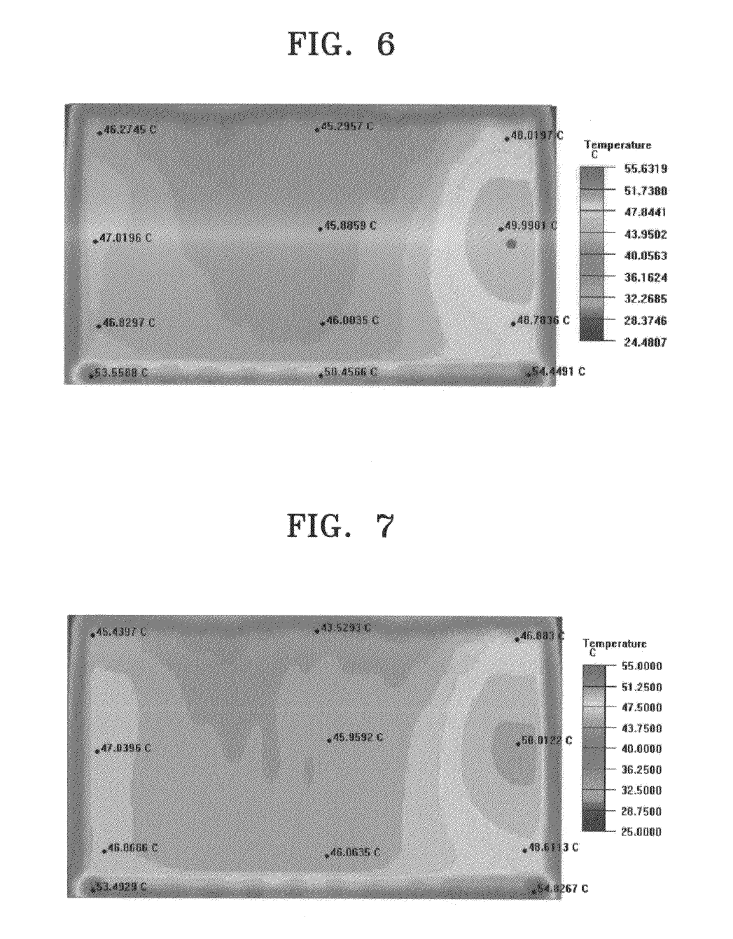

FIG. 6 is an image showing a temperature distribution in a test example of a plasma display apparatus according to an exemplary embodiment of the present invention. FIG. 7 is an image showing a temperature distribution in a range between 25° C.-55° C. in the test example of FIG. 6.

The test example of FIGS. 6 and 7 shows the temperature distributions generated when the PDP 10 is driven in the plasma display apparatus of FIG. 1. In the temperature distribution, it can be seen that the highest temperature occurs in the middle portion of the right side of the PDP 10. However, the highest temperature in FIGS. 6 and 7 is about 10° C. lower than that of the comparative test example shown in FIGS. 4 and 5. Also, the difference in temperature in the left and right sides of the PDP 10 is greatly improved so that the temperature may be uniformly distributed. This test result shows that the heated air flows upwardly through the channels 33 of the chassis base 30 so that heat may be effectively dissipated.

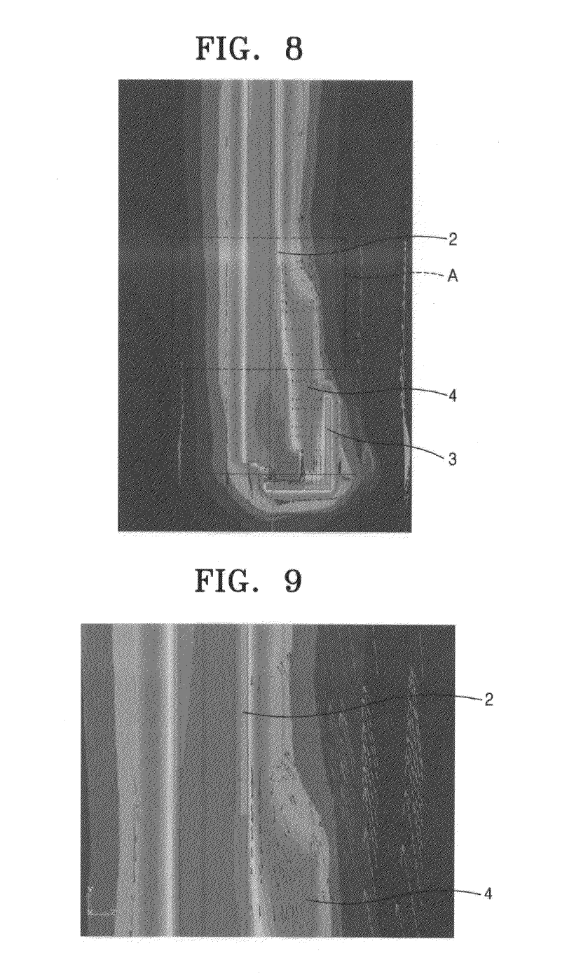

FIG. 8 is an image showing a temperature distribution, which illustrates air flow and a thermal boundary layer analyzed in a cross section of a center portion of the plasma display apparatus, in the comparative test example of FIG. 4. FIG. 9 is an image showing a temperature distribution by magnifying a portion A of FIG. 8. FIGS. 8 and 9 illustrate the temperature distribution in a cross section of a center portion of the plasma display apparatus.

A thermal boundary layer is a layer of fluid (e.g., an air layer) contacting a wall when thermal transfer is made between the wall and the fluid. The thermal boundary layer has the temperature ranging from the temperature of the wall to the temperature of the fluid. The thickness of the thermal boundary layer may vary according to the type, flow, thermal transfer characteristic of the fluid and the size and shape of a solid wall.

In the conventional plasma display apparatus having a flat chassis base as shown in FIGS. 8 and 9, the width of the thermal boundary layer is thick in the lower end portion of a protection plate 3. Also, the thermal boundary layer is maintained up to the upper portion of an address buffer board 4 and is slightly reduced at the rear surface of a chassis base 2. Thus, it can be seen that the flow of the heated air does not smoothly flow upwardly in the conventional plasma display apparatus because the thermal boundary layer is thick in the lower portion.

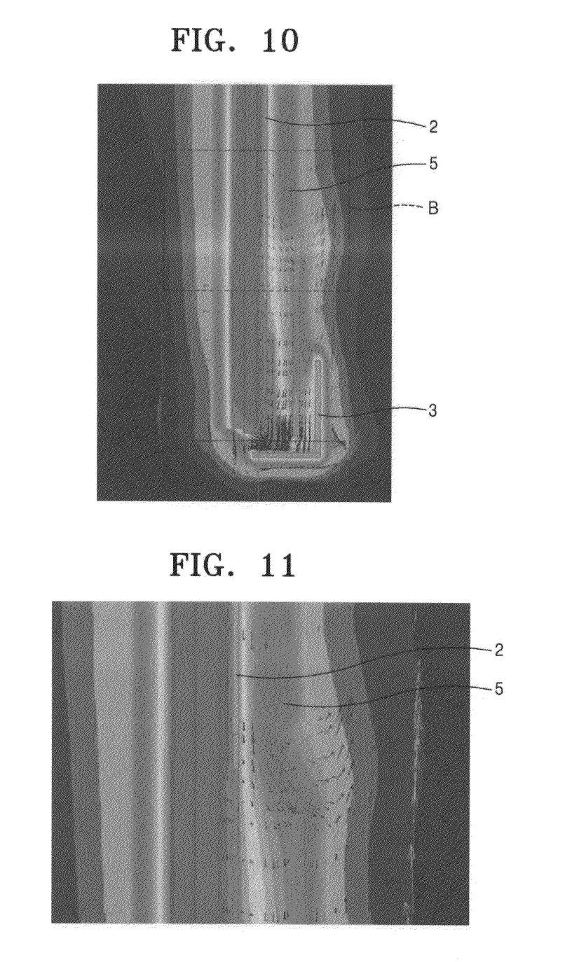

FIG. 10 is an image showing a temperature distribution, which illustrates air flow and a thermal boundary layer analyzed in a cross section where a scan buffer board of the plasma display apparatus in the comparative test example of FIG. 4 is present. FIG. 11 is an image showing a temperature distribution by magnifying a portion B of FIG. 10. FIGS. 10 and 11 illustrate the temperature distribution in a cross section passing a scan board arranged in the left side when the plasma display apparatus is viewed from the rear surface thereof.

The width of the thermal boundary layer in the lower end portion of the plasma display apparatus formed with a thick thickness around the protection plate 3 continues to a scan buffer board 5. The flow of air flowing downwardly between the lower end portion of the scan buffer board 5 and the chassis base 2 is observed. Thus, it can be seen that the heated air flows downwardly, not upwardly, because the passage of the air flow is blocked by the scan buffer board 5 because a thick thermal boundary layer is formed in the lower portion of the plasma display apparatus.

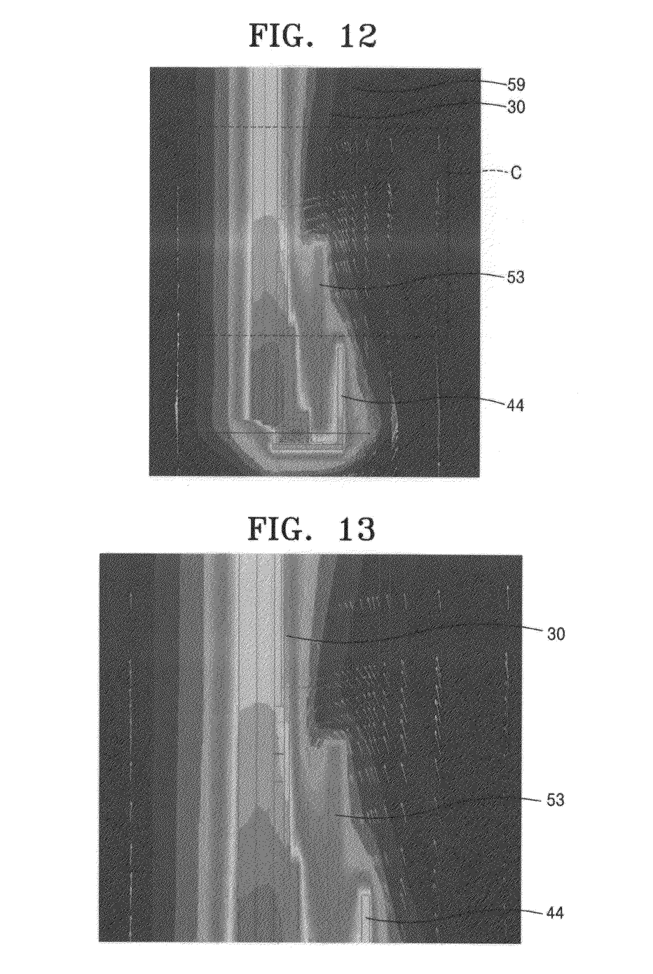

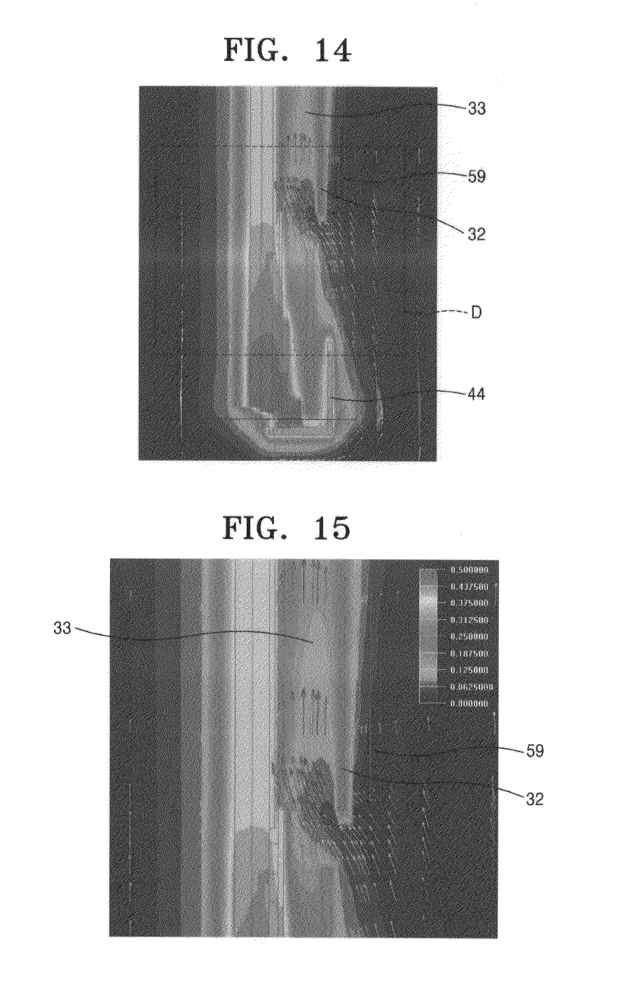

FIG. 12 is an image showing a temperature distribution, which illustrates air flow and a thermal boundary layer analyzed in a cross section of an installation portion of the plasma display apparatus, in a test example in relation with the exemplary embodiment of FIG. 1. FIG. 13 is an image showing a temperature distribution by magnifying a portion C of FIG. 12. FIGS. 12 and 13 illustrate the temperature distribution in a side cross section passing the installation portion 31 of the chassis base 30 in the plasma display apparatus of FIG. 1.

The temperature distribution in FIGS. 12 and 13 shows the smooth flow of air similar to those of FIGS. 8 and 9 in the conventional plasma display apparatus. That is, the thickness of the thermal boundary layer formed around the protection plate 44 is maintained up to the upper portion of the address buffer board 53. The thickness of the thermal boundary layer is reduced around the rear surface of the chassis base 30 and the circuit board 59.

FIG. 14 is an image showing a temperature distribution, which illustrates air flow and a thermal boundary layer analyzed in a cross section of a connection portion of the plasma display apparatus, in a test example in relation with the exemplary embodiment of FIG. 1. FIG. 15 is an image showing a temperature distribution by magnifying a portion D of FIG. 14. FIGS. 14 and 15 illustrate the temperature distribution in a side cross section passing the connection portion 32 of the chassis base 30 in the plasma display apparatus of FIG. 1.

The thickness of the thermal boundary layer formed around the protection plate 44 is drastically reduced in the connection portion 32 of the chassis base 30. Accordingly, the air flows upwardly through the channels 33 formed by the connection portions 32 so that heat is not accumulated and exhausted outwardly.

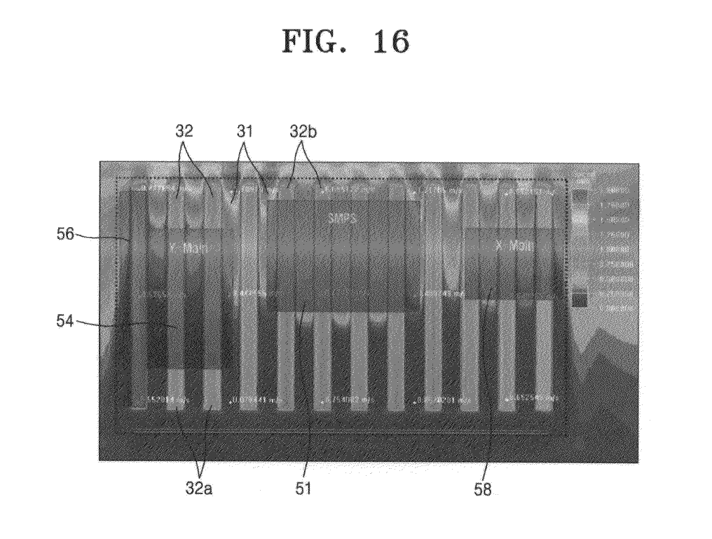

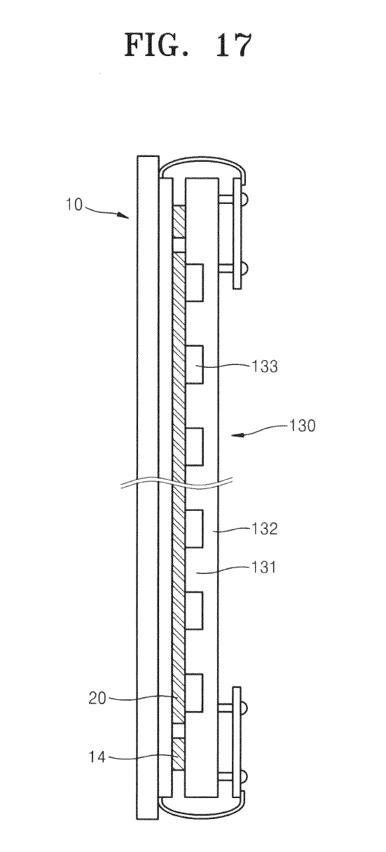

FIG. 16 is an image showing the fluid velocity distribution of the plasma display apparatus in a test example in relation with the exemplary embodiment of FIG. 1. In FIG. 16, there is not much difference in the velocity of the fluid at an entrance portion 32a at the lower side of each of the connection portions 32 and an exit portion 32b at the upper side of each of the connection portions 32. Thus, it can be seen that the connection portions 32 play an important role in the transfer and exhaust of most heat across the overall area of the chassis base 30.

On the other hand, it can be seen that, compared to the connection portions 32, the velocity is slow in the lower portion of each of the installation portions 31 but slightly increased in the upper portion. This is because the heated air does not flow upwardly in the lower side of the chassis base 30 due to structures such as the circuit boards 51, 52, 53, 54, 56, and 58 installed on the chassis base 30 so that the velocity of air flow may be slow and, in the upper side of the chassis base 30, the flow of air is fast due to the heat generated during the operation of the circuit boards 51, 52, 53, 54, 56, and 58.

FIG. 17 is a top cross-sectional view of a plasma display apparatus according to another exemplary embodiment of the present invention. Referring to FIG. 17, a plasma display apparatus of the present exemplary embodiment includes the PDP 10 for forming an image using a gas discharge phenomenon, the thermal conductive medium 20 arranged on the rear surface of the PDP 10, and a chassis base 130. The rear surface of the PDP 10 and the front surface of the chassis base 130 are attached to each other using the double-sided adhesive tape 14.

A plurality of channels 133 are formed in the front surface of the chassis base 130 facing the thermal conductive medium 20. The channels 133 extend in a vertical direction of the chassis base 130 to guide heated air to flow upwardly.

The chassis base 130 includes a plurality of installation portions 131 attached to the PDP 10 via the thermal conductive medium 20 and a plurality of connection portions 132 connecting the installation portions 131. The connection portions 132 are separated from the thermal conductive medium 20 in a direction away from the PDP 10, thus forming the channels 133. The channels 133 may be formed in a variety of methods, for example, by pressing or cutting a flat raw material, or in a die-casting method.

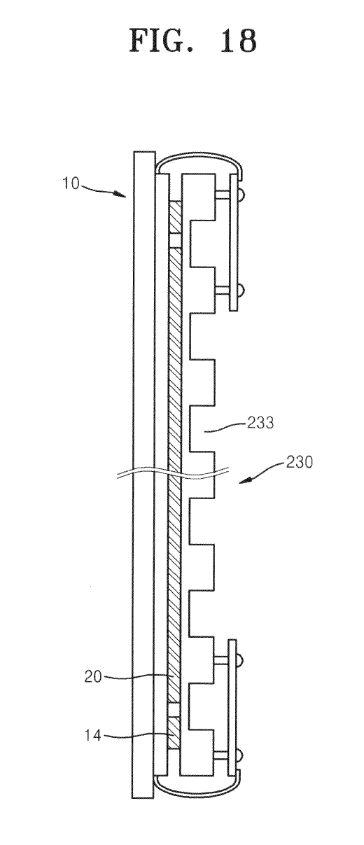

FIG. 18 is a top cross-sectional view of a plasma display apparatus according to another exemplary embodiment of the present invention. Referring to FIG. 18, a plasma display apparatus of the present exemplary embodiment includes the PDP 10 for forming an image using a gas discharge phenomenon, the thermal conductive medium 20 arranged on the rear surface of the PDP 10, and a chassis base 230. The rear surface of the PDP 10 and the front surface of the chassis base 230 are attached to each other using the double-sided adhesive tape 14.

A plurality of channels 233 are formed in the rear surface of the chassis base 230 on the side opposite to the thermal conductive medium 20. The channels 233 extend in a vertical direction of the chassis base 230 to guide heated air to flow upwardly. Since the channels 233 are formed to avoid the circuit boards 51, 52, 53, 54, 56, and 58, the channels 233 may work as a passage for the air flow.

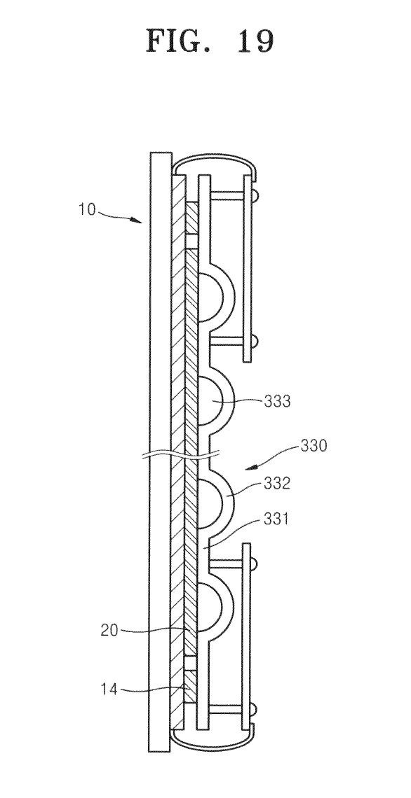

FIG. 19 is a top cross-sectional view of a plasma display apparatus according to another exemplary embodiment of the present invention. Referring to FIG. 19, a plasma display apparatus of the present exemplary embodiment includes the PDP 10 for forming an image using a gas discharge phenomenon, the thermal conductive medium 20 arranged on the rear surface of the PDP 10, and a chassis base 330. The rear surface of the PDP 10 and the front surface of the chassis base 330 are attached to each other using the double-sided adhesive tape 14.

A plurality of channels 333 are formed in the front surface of the chassis base 330 facing the thermal conductive medium 20. The channels 333 extend in a vertical direction of the chassis base 330 to guide heated air to flow upwardly.

The chassis base 330 includes a plurality of installation portions 331 attached to the PDP 10 via the thermal conductive medium 20 and a plurality of connection portions 332 connecting the installation portions 331. Each of the connection portions 332 forms a duct that is bent to have a convex cross section protruding away from the PDP 10 to form the channels 333. Thus, the channels 333 may work as a passage for the flow of heated air.

In the exemplary embodiment of FIG. 19, the cross section of each of the connection portions 332 forms a curve. However, the present invention is not limited thereto and the cross section of the connection portion 332 may be a polygon so that the cross section of the connection portion 332 may be formed in a duct shape having a rectangular or triangular cross section.

As described above, in the plasma display apparatus according to the exemplary embodiments of the present invention, since the channels for guiding heated air to flow upwardly are provided in the chassis base, heat may be efficiently dissipated without increasing the thickness of the chassis base.

While the present invention has been particularly shown and described with reference to exemplary embodiments thereof, it will be understood by those of ordinary skill in the art that various changes in form and details may be made therein without departing from the spirit and scope of the present invention as defined by the following claims and their equivalents.

What is claimed is:

1. A plasma display apparatus comprising:
a plasma display panel;
a chassis base at the rear of the plasma display panel and having a plurality of channels for guiding heated air to flow upwardly; and
a thermal conductive medium between the plasma display panel and the chassis base.

2. The plasma display apparatus of claim 1, wherein the channels extend upwardly in the chassis base.

3. The plasma display apparatus of claim 2, wherein the channels are on a side of the chassis base facing the thermal conductive medium.

4. The plasma display apparatus of claim 2, wherein the channels are on a side of the chassis base opposite from the thermal conductive medium.

5. The plasma display apparatus of claim 2, wherein each of the channels forms a duct having a convex cross section protruding away from the chassis base in a direction away from the thermal conductive medium.

6. A plasma display apparatus comprising:
a plasma display panel;
a thermal conductive medium at the rear of the plasma display panel; and
a chassis base having a plurality of installation portions, the installation portions attached to the plasma display panel via the thermal conductive medium between the installation portions and the plasma display panel, and a plurality of connection portions connecting the installation portions and protruding in an opposite direction from the plasma display panel to be separated from the thermal conductive medium.

7. The plasma display apparatus of claim 6, wherein the installation portions and the connection portions vertically extend in the chassis base.

8. The plasma display apparatus of claim 7, wherein the cross section of each of the connection portions has a polygonal shape.

9. The plasma display apparatus of claim 7, wherein the cross section of each of the connection portions has a shape of a circular arc.

10. A plasma display apparatus comprising:
a plasma display panel;
a chassis base thermally coupled to the plasma display panel; and
driving circuits on a side of the chassis base opposite from the plasma display panel,
wherein the chassis base is adapted to provide a plurality of air channels substantially separated from air flow across the driving circuits for guiding air heated by the plasma display panel.

11. The plasma display apparatus of claim 10, wherein the air channels are on a surface of the chassis base facing the plasma display panel.

12. The plasma display apparatus of claim 10, wherein each of the air channels has a convex cross section protruding from the chassis base in a direction away from the plasma display panel.

13. The plasma display apparatus of claim 10, further comprising a thermal conductive medium between the plasma display panel and the chassis base.
